(19) United States
(12) Patent Application Publication
(10) Pub. No.: US 2010/0199458 A1
(43) Pub. Date: Aug. 12, 2010

(54) Electricity-conducting wheel structure

(76) Inventor: Li-Lan Yan, Puzih City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/379,005

(22) Filed: Feb. 11, 2009

(51) Int. Cl. B60B 33/00

(52) U.S. Cl. 16/45

(57) ABSTRACT

An electricity-conducting wheel includes a holding member, a wheel member, an electricity conducting plate, and an intermediate electricity conducting piece; the holding member is joined on a metallic bearing joined on a lower end of a rotary shaft on a bottom of a hospital bed/wheelchair, and has a pivotal hole thereon; the wheel member is joined on the holding member with a shaft being passed through the pivotal hole of the holding member; the electricity conducting plate is securely joined around the bearing, and wrapped in the holding member, and it has a bending electricity conducting part on a lower end thereof; the intermediate piece has an electricity conducting part on an upper end, and it is connected to the electricity conducting plate at the upper electricity conducting part; the intermediate piece has a hole on a lower end thereof, through which the shaft of the wheel member is passed.

### BACKGROUND OF THE INVENTION

1. Field of the invention

The present invention relates to an improvement on an electricity conducting wheel, more particularly one, which has a relatively long service life and simple structure, and can't get damaged easily even if it hits against other objects.

2. Brief Description of the Prior Art

Patients are usually transported from a sick chamber with vehicles, e.g. wheelchairs and wheeled hospital beds, to the examination division to have a medical examination such as computerized axial tomography scan and nuclear magnetic resonance radiography.

However, when such vehicles are moving, static electricity will be produced thereon owing to the vehicles rubbing against other objects, especially in cold, dry, and low-humidity seasons, which static electricity will cause shock and discomfort to the patients on the vehicles. If a patient has a medical examination with a high-precision medical examination apparatus while resting on the vehicle, the static electricity will interfere with the medical examination apparatus. Consequently, errors are prone to happen to the outcome of the examination.

To overcome the above-mentioned problems, the inventor of the present invention developed an improvement on an electricity conducting roller structure, and an improvement on an electricity conducting wheel structure, which were taught in the present inventor's U.S. patent applications Ser. Nos. 11/790,101 and 11/976,479 respectively. Both the above-mentioned electricity conducting wheels are to be fitted on the frame parts of the casters of a hospital bed/wheelchair to ground the static electricity carried on the hospital bed/wheelchair, thus preventing the static electricity from causing shock and discomfort to the patients or interfering with the medical examination.

However, the above-mentioned electricity conducting roller/wheel structures have the following drawbacks:

1. The manufacturers have to spend considerable amount of time and labor assembling the electricity conducting roller/wheel and joining the roller/wheel on the casters of a hospital bed/wheelchair. Therefore, the roller/wheel will cause a significant increase in the manufacturing cost of the casters.

2. The electricity conducting roller/wheel has a smaller size than the casters of a hospital bed/wheelchair, and therefore is prone to get damaged when hitting against holes and bumps on an uneven floor/road.

Therefore, it is a main object of the present invention to provide an improvement on an electricity-conducting wheel structure to overcome the above problems.

### SUMMARY OF THE INVENTION

An electricity-conducting wheel in accordance with an embodiment of the present invention consists of:

a holding member, which is joined on a metallic bearing joined on a lower end of a rotary shaft on a bottom of a hospital bed/wheelchair; the holding member has a pivotal hole thereon;

a wheel member, which is joined on the holding member with a shaft thereof being passed through the pivotal hole of the holding member;

an electricity conducting plate, which is securely joined around the bearing, and buried in the holding member; the electricity conducting plate has a bending electricity conducting part on a lower end thereof; and

an intermediate electricity conducting piece, which has an electricity conducting part on an upper end, and is connected to the electricity conducting plate at the upper electricity conducting part; the electricity conducting piece has a hole on a lower end thereof, through which the shaft of the wheel member is passed.

Therefore, static electricity carried on the hospital bed/wheelchair can be grounded through the rotary shaft, the bearing, the electricity conducting plate, the electricity conducting piece, and the wheel member.

### BRIEF DESCRIPTION OF THE DRAWINGS

The present invention will be better understood by referring to the accompanying drawings, wherein:

FIG. 1 is an exploded perspective view of the present invention,

FIG. 2 is a horizontal sectional view of the present invention,

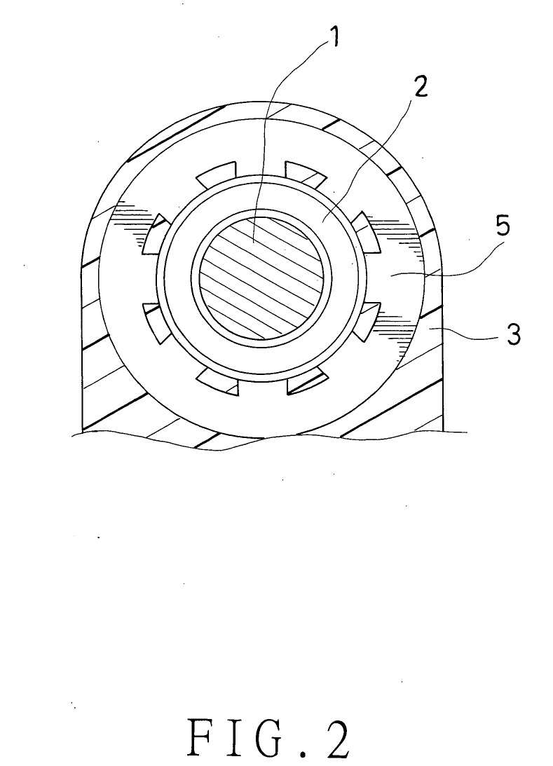

FIG. 3 is a lateral sectional view of the present invention,

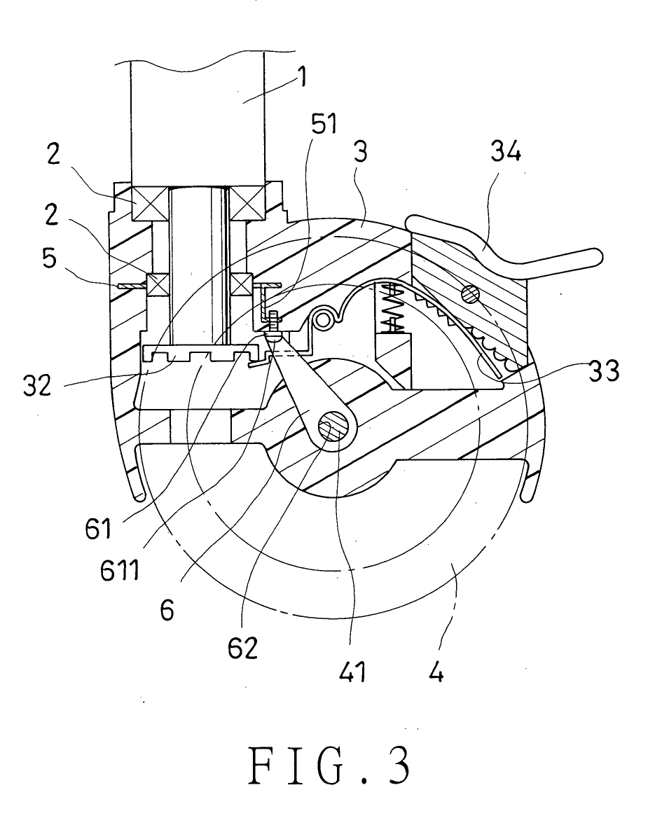

FIG. 4 is a front sectional view of the present invention,

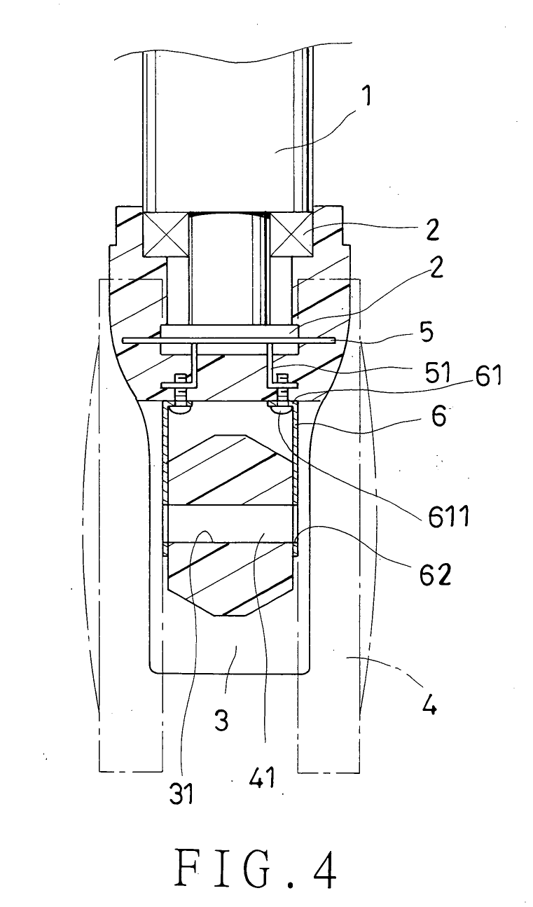

FIG. 5 is an exploded perspective view of the first preferred embodiment,

FIG. 6 is a sectional view of the first preferred embodiment,

FIG. 7 is an exploded perspective view of the second preferred embodiment,

FIG. 8 is a sectional view of the second preferred embodiment, and

FIG. 9 is an exploded perspective view of the third preferred embodiment.

### DETAILED DESCRIPTION OF THE PREFERRED EMBODIMENTS

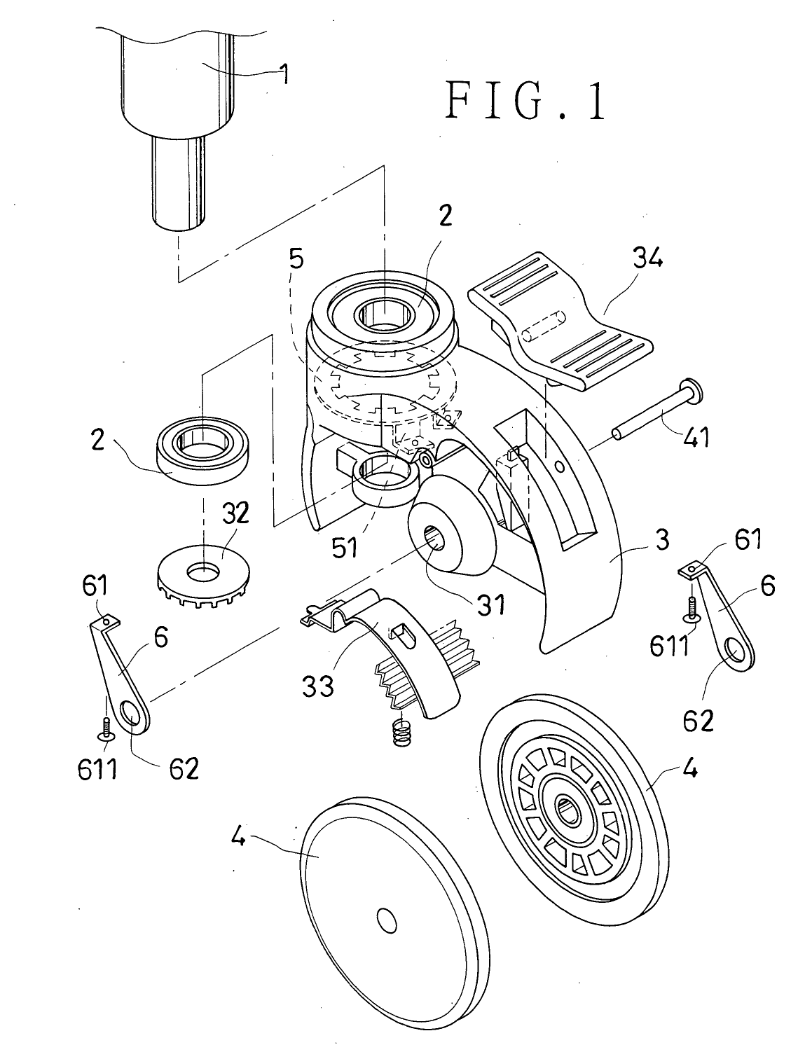

Referring to FIG. 1 to FIG. 1, an electricity conducting wheel of the present invention consists of:

a holding member 3, which is made of plastic materials, and joined on a metallic bearing 2 joined on a lower end of a rotary shaft 1; the holding member 3 has a pivotal hole 31;

a toothed disc 32, which is positioned right under the rotary shaft 1 in the holding member 3;

a brake pad 33 positioned next to the toothed disc 32;

a pedal 34, which is pivoted to the holding member 3, and which will force the brake pad 33 to engage the toothed disc 32 when it is pressed;

two wheel members 4, which have electricity conductivity, and are joined on the holding member 3 with a shaft 41 thereof being passed through the pivotal hole 31 of the holding member 3;

an electricity conducting plate 5, which is securely positioned around the bearing 2, and buried in the holding member 3; the electricity conducting plate 5 has two lower bending electricity conducting parts 51, which are also buried in the holding member 3; and

two intermediate electricity conducting pieces 6, which are connected to the electricity conducting plate 5; each of the electricity conducting pieces 6 has an upper electricity conducting part 61, and a lower through hole 62; the upper electricity conducting parts 61 of the electricity conducting pieces 6 are joined to the lower bending electricity conducting parts 51 of the electricity conducting plate 5 respectively with a connecting piece 611, and the shaft 41 is passed through the lower through holes 62 of the electricity conducting pieces 6 so that static electricity carried on a hospital bed/wheelchair can be grounded through the rotary shaft 1, the bearing 2, the electricity conducting plate 5, the electricity conducting pieces 6, and the wheel members 4.

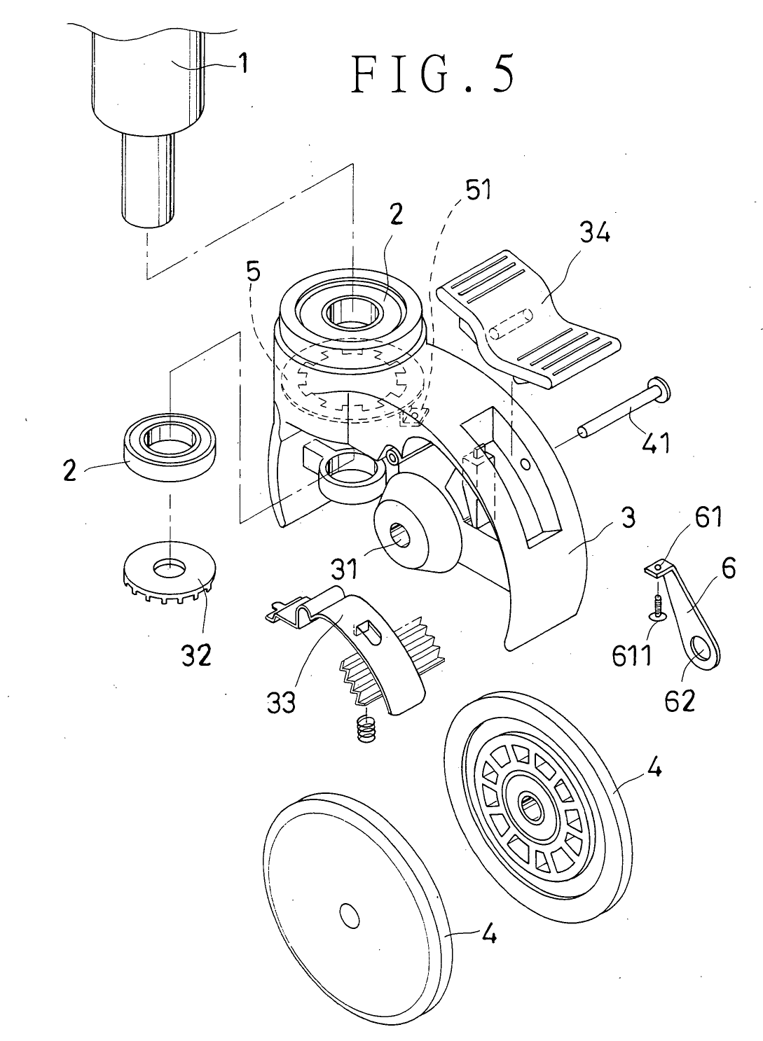

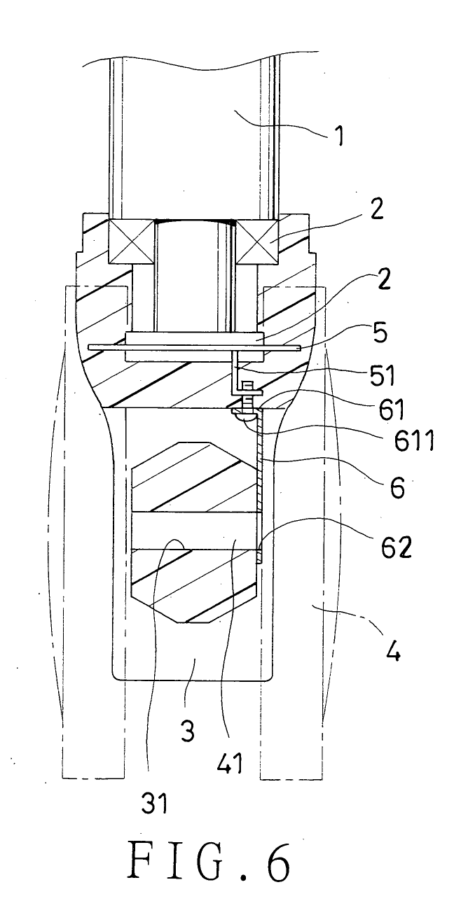

Shown in FIGS. 5 and 6 is the first preferred embodiment of an electricity conducting wheel of the present invention, which consists of two wheel members 4, and only one electricity conducting piece 6 instead of the above-mentioned two electricity conducting pieces 6.

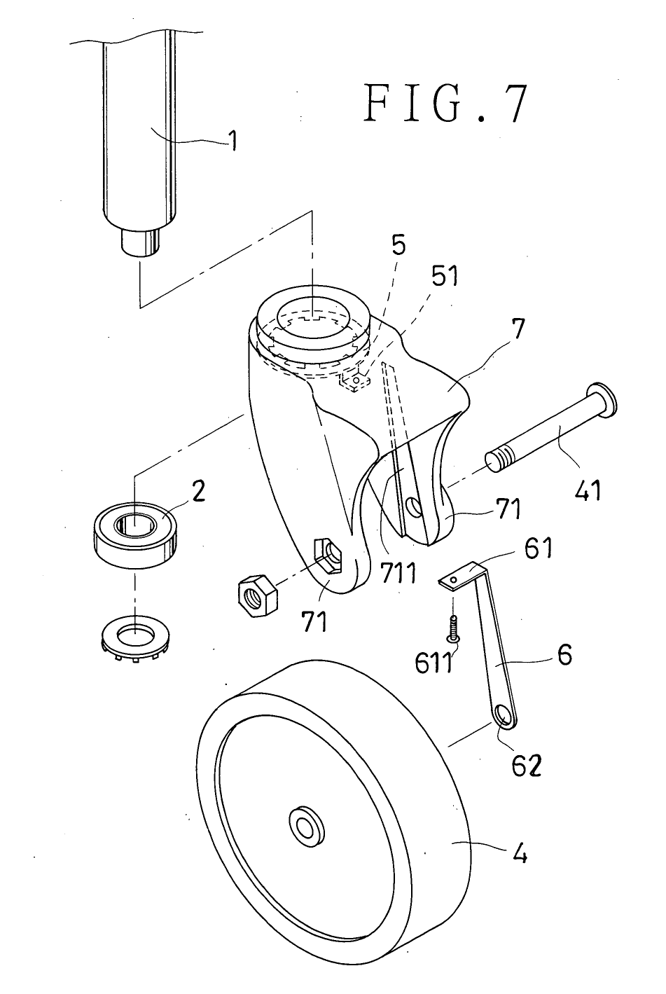

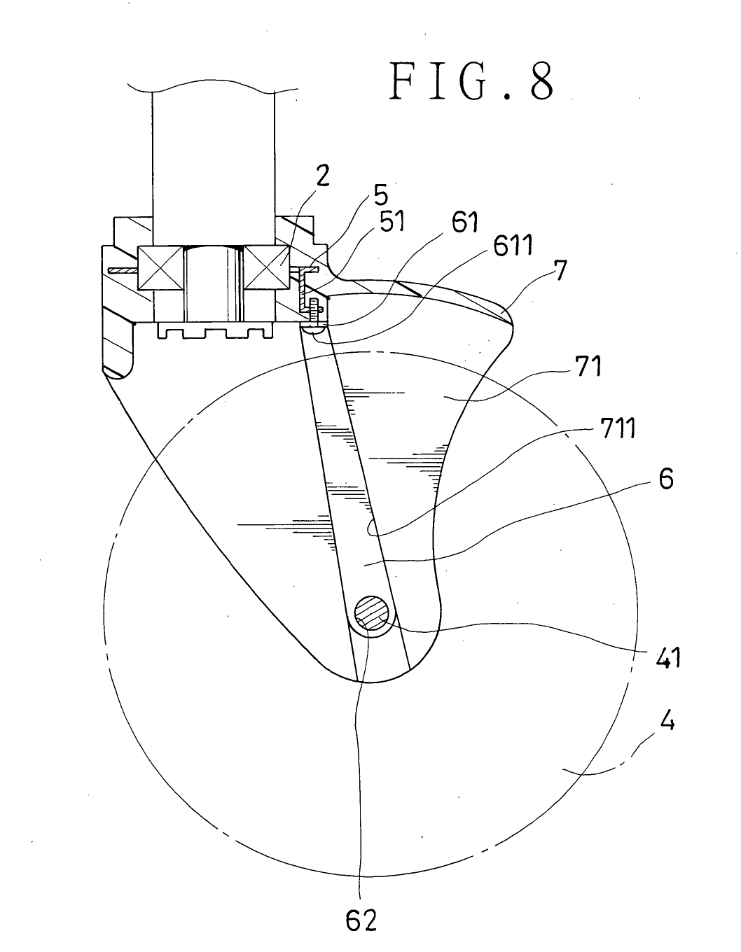

Shown in FIGS. 7 and 8 is the second preferred embodiment of an electricity conducting wheel of the present invention, which consists of a holding member 7, single wheel member 4, and single electricity conducting piece 6; the holding member 7 has two lateral plate parts 71, and a first one of the lateral plate parts 71 has a recessed portion 711 on an inner side thereof; the electricity conducting piece 6 is held in the recessed portion 711 of said first lateral plate part 71 of the holding member 7. The electricity conducting piece 6 can be put in a mold of the holding member 7, and directly buried in and joined to the holding member 7 when an injection molding process is carried out to form the holding member 7.

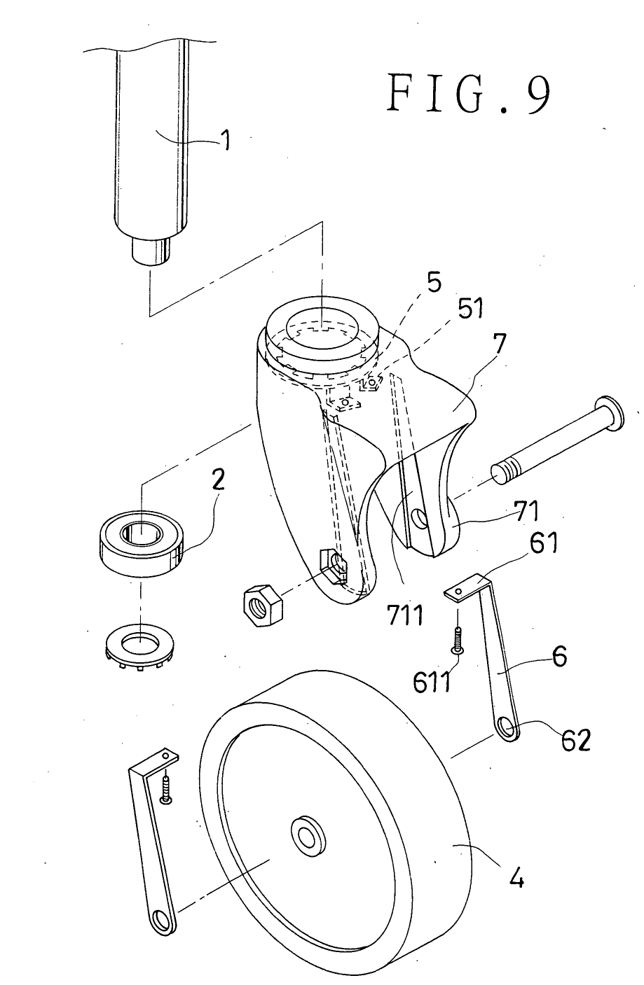

Shown in FIG. 9 is the third preferred embodiment of an electricity conducting wheel of the present invention, which consists of a holding member 7, single wheel member 4, and two electricity conducting pieces 6; the holding member 7 has two lateral plate parts 71, which each have a recessed portion 711 on an inner side thereof; the electricity conducting pieces 6 are held in the recessed portions 711 of the lateral plate parts 71 of the holding member 7 respectively.

From the above description, it can be seen that the present invention has the following advantages over the prior arts:

1. The electricity conducting wheel of the present invention has a relatively simple structure, and it takes less time and fewer steps to manufacture the present electricity conducting wheel. Therefore, the manufacturing cost of the wheel reduces.

2. The wheel of the present invention is equipped with the intermediate electricity conducting piece, which connects the electricity conducting plate to the wheel member. Therefore, the electricity conducting plate can't get damaged even if the wheel hits against holes and bumps on an uneven floor/road.

What is claimed is:

1. An improvement on an electricity conducting wheel structure, comprising
a holding member joined on a metallic bearing joined on a lower end of a rotary shaft; the holding member having a pivotal hole thereon;
at least one wheel member, which is joined on the holding member with a shaft thereof being passed through the pivotal hole of the holding member;
an electricity conducting plate, which is securely positioned around the bearing, and buried in the holding member; the electricity conducting plate having a plurality of lower bending electricity conducting parts; and
at least one intermediate electricity conducting piece connected to the electricity conducting plate; the electricity conducting piece having an electricity conducting part on an upper end; the electricity conducting piece having a through hole on other end thereof, through which the shaft of the wheel member is passed.

2. The improvement on an electricity conducting wheel structure as claimed in claim 1 comprising single wheel member, and single intermediate electricity conducting piece, which is positioned on one side of the wheel member.

3. The improvement on an electricity conducting wheel structure as claimed in claim 2, wherein the holding member has a lateral plate part; the lateral plate part having a recessed portion on an inner side thereof; the intermediate electricity conducting piece being held in the recessed portion of the lateral plate part of the holding member.

4. The improvement on an electricity conducting wheel structure as claimed in claim 2, wherein the intermediate electricity conducting piece is directly buried in and joined to the holding member when an injection molding process is carried out to form the holding member.

5. The improvement on an electricity conducting wheel structure as claimed in claim 1 comprising single wheel member, and two intermediate electricity conducting pieces, which are positioned on two sides of the wheel member respectively.

6. The improvement on an electricity conducting wheel structure as claimed in claim 5, wherein the holding member has two lateral plate parts; the lateral plate parts each having a recessed portion on an inner side thereof; the intermediate electricity conducting pieces being held in the recessed portions of the lateral plate parts respectively.

7. The improvement on an electricity conducting wheel structure as claimed in claim 5, wherein the intermediate electricity conducting pieces are directly buried in and joined to the holding member when an injection molding process is carried out to form the holding member.

8. The improvement on an electricity conducting wheel structure as claimed in claim 1 comprising two wheel members, and single intermediate electricity conducting piece, which is positioned on one side of one of the wheel members.

9. The improvement on an electricity conducting wheel structure as claimed in claim 1 comprising two wheel members, and two intermediate electricity conducting pieces, which are positioned on lateral sides of the wheel members respectively.

10. The improvement on an electricity conducting wheel structure as claimed in claim 1, wherein holding member is made of plastic materials.
